(19) United States
(12) Patent Application Publication
(10) Pub. No.: US 2026/0072984 A1
(43) Pub. Date: Mar. 12, 2026

(54) QUESTION ANSWER SYSTEM BASED ON ANALYSIS OF SPEECH AND IMAGE IN VIDEO AND OPERATION METHOD THEREFOR

(71) Applicant: DATAEDU Inc., Busan (KR)

(72) Inventor: Jongsik YOON, Busan (KR)

(73) Assignee: DATAEDU Inc., Busan (KR)

(21) Appl. No.: 18/830,698

(22) Filed: Sep. 11, 2024

(51) Int. Cl. G06F 16/735; G06F 16/738; G06F 40/166; G06V 20/40; G10L 15/18; G10L 25/57

(52) U.S. Cl. CPC G06F 16/735; G06F 16/738; G06F 40/166; G06V 20/49; G10L 15/18; G10L 25/57

(57) ABSTRACT

A question answer system for automatically generating an answer to a question of a user according to an exemplary embodiment of the present disclosure includes a user interface configured to receive a video URL address and the question from the user, a video analysis unit configured to download a video through the video URL address, divide the video into a plurality of sections, and recognize a speech, convert the speech into text, and extract text included in an image for each section to generate content of the video as text data, and a machine reading comprehension engine configured to receive the text data from the video analysis unit and extract the answer to the question from the text data.

### TECHNICAL FIELD

The technical idea of the present disclosure relates to a question answer system and an operation method therefor, and more specifically, to a question answer system based on analysis of a speech and image in a video and an operation method therefor.

### BACKGROUND

Recently, Internet users often obtain desired information through videos on video platforms rather than portal sites. As the video platforms evolve from platforms on which videos can be shared to search engines, a need for an automatic question answer system or ChatBot that can determine whether information to be looked for by a user is included in video content through search is increasing. However, since an existing question answer system provides search results based on a title and description of the video, there is a problem that it is difficult for information included as a speech or image in a video to be provided as the search results.

### SUMMARY

The technical idea of the present disclosure is to provide a question answer system for providing a highly reliable answer to the content of a video based on analysis of a speech and image in the video.

A question answer system for automatically generating an answer to a question of a user according to an exemplary embodiment of the present disclosure includes a user interface configured to receive a video URL address and the question from the user; a video analysis unit configured to download a video through the video URL address, divide the video into a plurality of sections, and recognize a speech, convert the speech into text, and extract text included in an image for each section to generate content of the video as text data; and a machine reading comprehension engine configured to receive the text data from the video analysis unit and extract the answer to the question from the text data.

The machine reading comprehension engine according to an exemplary embodiment of the present disclosure is configured to extract a time stamp value of the section including the answer to the question.

The video analysis unit according to an exemplary embodiment of the present disclosure is configured to receive the time stamp value from the machine reading comprehension engine, determine the section of the video corresponding to the time stamp value, and display the answer to the question and the determined section of the video on the user interface.

The video analysis unit according to an exemplary embodiment of the present disclosure is configured to generate a morpheme tag corresponding to a name of each brand belonging to health and fashion fields, recognize a sentence from the speech, and perform morpheme analysis on the sentence based on the morpheme tag, thereby extracting the text from the sentence.

The question answer system according to an exemplary embodiment of the present disclosure may further include a database, wherein the video analysis unit is configured to map a section of the video to the text data and store the section and the text data in the database.

The question answer system according to an exemplary embodiment of the present disclosure further includes a search engine. The search engine is configured to receive a search request from the user interface, the search request being a search request for a video including a specific keyword, and search for text data corresponding to the keyword among information stored in the database.

The search engine is configured to extract one or more videos including the text data and display the video including the keyword as a search result through the user interface.

The video analysis unit according to an exemplary embodiment of the present disclosure is configured to divide the video based on a screen switching point.

The user interface according to an exemplary embodiment of the present disclosure includes a first interface, a second interface, a third interface, and a fourth interface,

The first interface is an interface for receiving a video URL address indicating a path to which a video file belongs from a user, and

The second interface is an interface for displaying sections divided from a video by at least one processor and a time stamp corresponding to each section.

The third interface is an interface for receiving a question from a user.

The fourth interface is an interface for displaying the answer to the question and the section of the video including the answer to the question.

An operation method for a question answer system for automatically generating an answer to a question of a user using at least one processor according to an exemplary embodiment of the present disclosure includes receiving a video URL address and a question from a user by a user interface and the at least one processor; downloading, by the at least one processor, a video through the video URL address and dividing the video into a plurality of sections; generating, by the at least one processor, the content of the video as text data by recognizing a speech, converting the speech into text, and extracting text included in an image for each section; and extracting, by the at least one processor, the answer to the question from the text data using a learned machine reading comprehension algorithm.

The extracting of the answer to the question according to an exemplary embodiment of the present disclosure includes extracting the time stamp value of the section including the answer to the question; determining the section of the video corresponding to the time stamp value; and displaying the answer to the question and the determined section of the video.

The generating of the content of the video as text data according to an exemplary embodiment of the present disclosure includes generating a morphological tag corresponding to a name of each brand belonging to health and fashion fields; recognizing a sentence from the speech; performing morpheme analysis on the sentence based on the morpheme tag; and extracting the text from the sentence based on the morpheme analysis.

The operation method for a question answer system according to an exemplary embodiment of the present disclosure further include mapping a section of the video to the text data and storing the section and the text data in a database.

The operation method for a question answer system according to an exemplary embodiment of the present disclosure further includes receiving, by a search engine, a search request from the user interface, the search request being a search request for a video including a specific keyword; and searching for, by the search engine, text data corresponding to the keyword among information stored in the database.

The operation method for a question answer system according to an exemplary embodiment of the present disclosure further includes extracting, by the search engine, one or more videos including the text data; and displaying, by the search engine, a video including the keyword as a search result through the user interface.

The dividing of the video into the plurality of sections according to an exemplary embodiment of the present disclosure includes dividing the video based on a screen switching point.

Further, according to an exemplary embodiment of the present disclosure, there is provided a computer-readable non-transitory recording medium having a computer program for executing the operation method for a question answer system according to claim 11 recorded thereon.

The question answer system according to an exemplary embodiment of the present disclosure may expand an analysis range of a video to a speech and an image, analyze the content of the video, and provide the answer to the question of the user based on the analyzed content.

The question answer system according to the exemplary embodiment of the present disclosure may provide particularly reliable search results for a video (for example, a video in the health and fashion fields) that provides information in the form of an image within the video.

### BRIEF DESCRIPTION OF THE DRAWINGS

FIG. 1 is a block diagram illustrating a question answer system according to an exemplary embodiment of the present disclosure.

FIG. 2 is a block diagram illustrating a machine reading comprehension engine according to an exemplary embodiment of the present disclosure.

FIG. 3 shows a user interface according to an exemplary embodiment of the present disclosure.

FIG. 4 is a flowchart showing an operation method for a question answer system according to an exemplary embodiment of the present disclosure.

FIG. 5 is a block diagram illustrating a video search system according to an exemplary embodiment of the present disclosure.

FIG. 6 is a block diagram illustrating a question answer system according to an exemplary embodiment of the present disclosure.

### DETAILED DESCRIPTION

Hereinafter, embodiments of the present disclosure will be described in detail with reference to the accompanying drawings. In the following description, when there is concern that the gist of the present disclosure may be unnecessarily obscured, specific descriptions of well-known functions or configurations will be omitted. In the accompanying drawings, the same or corresponding components are denoted by the same reference signs as much as possible. In the description of embodiments below, description of the same or corresponding components may be omitted. However, even when the description of the components is omitted, it is not intended that such components are not included in any embodiment.

The advantages and features of the embodiments disclosed in the present specification, and methods for achieving these will become clear with reference to the embodiments to be described below together with the accompanying drawings. However, the present disclosure is not limited to the embodiments to be disclosed below, but may be implemented in various different forms, and the present embodiments are only provided to fully inform those skilled in the art related to the present disclosure of the scope of the invention.

The terms used in the present specification will be briefly described, and disclosed embodiments will be specifically described. The terms used in the present specification have been selected as general terms currently widely used as much as possible in consideration of functions in the present disclosure, but this may vary depending on the intention of technicians engaged in the relevant field, precedents, or the emergence of new technologies. Further, in specific cases, there are terms arbitrarily selected by the applicant, and in such cases, meanings of terms will be described in detail in a corresponding part of the disclosure. Therefore, the terms used in the present disclosure should be defined based on meanings of the terms and the overall content of the present disclosure, rather than names of the terms.

In the present specification, singular expressions include plural expressions unless the context clearly specifies being singular. Further, the plural expressions include singular expressions unless the context clearly specifies being plural. In the entire specification, when a certain portion includes a certain component, this means that the portion does not exclude another component, but rather may include the other component unless otherwise particularly stated.

In the present disclosure, the terms such as “comprise” and “comprising” may indicate the presence of features, steps, operations, elements, and/or components, and such terms do not exclude the addition of one or more other functions, steps, operations, elements, components, and/or combinations thereof.

In the present disclosure, when a specific component is referred to as being “coupled to,” “combined with,” “connected to,” “associated with,” or “reacting to” any other component, the specific component may be directly coupled to, combined with, connected to, and/or associated with or react to the other component, but the present disclosure is not limited thereto. For example, one or more intermediate components may exist between the specific component and the other component. Further, “and/or” in the present disclosure may include each of one or more listed items, or a combination of at least some of one or more listed items.

In the present disclosure, terms such as ‘first’, ‘second’, and the like are used to distinguish a specific component from other components, and the components described above are not limited by these terms. For example, a ‘first’ component may be used to refer to an element having the same or similar form as the ‘second’ component.

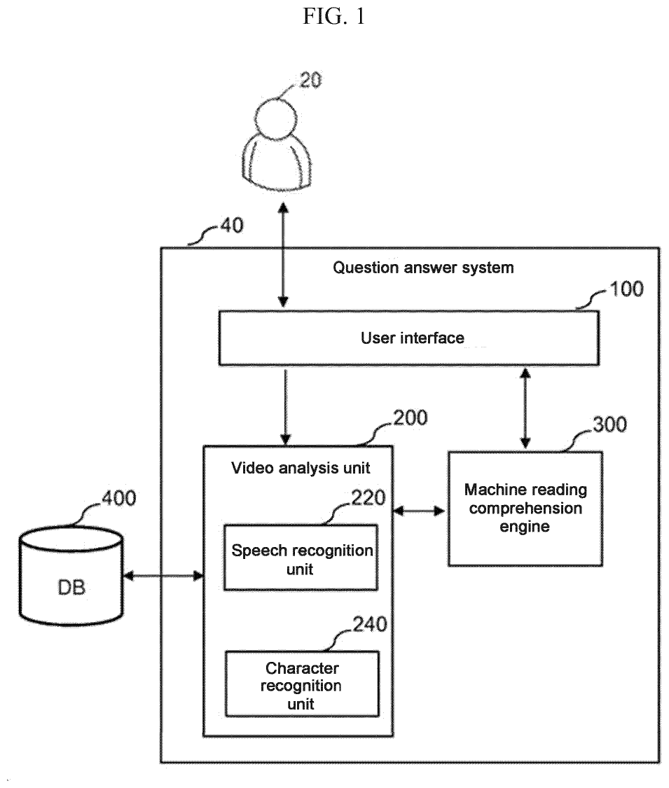

FIG. 1 is a block diagram illustrating a question answer system according to an exemplary embodiment of the present disclosure. Referring to FIG. 1, a question answer system 40 may analyze the content of an image and provide an answer to a question to a user 20 based on the analyzed content. The question answer system 40 may be an automatic question answer system that provides the answer to the question received from the user 20 through a machine reading comprehension model learned by deep learning.

A video in the health and fashion fields often includes text within a screen to provide information. For example, in a video with a health topic such as health knowledge, health foods, and medicines, specialized terms such as medicines and ingredients are shown as images within the video. Further, in a video with a fashion topic such as clothing, beauty, hair, and miscellaneous goods, product information such as product names, sales locations, colors, prices, and related brands is shown as an image in the video.

The question answer system according to the exemplary embodiment of the present disclosure may expand an analysis range of a video from speech to an image, and generate text data from the speech and the image in the video. The machine reading comprehension engine may determine whether information to be looked for by the user is included in video content through search by extracting the answer to the question from the text data.

The question answer system 40 may include a user interface 100, a video analysis unit 200, a machine reading comprehension engine 300, and a database 400. The user interface 100 may receive the video URL address and the question from the user 20. The video URL address may be an address indicating a path to which the video file belongs, and the question may be a question for the content of the video included in the video URL address.

The user interface 100 may provide the video URL address received from the user 20 to the video analysis unit 200. The user interface 100 may provide a question received from the user 20 to the machine reading comprehension engine 300. The user interface 100 may provide an answer derived from the machine reading comprehension engine 300 to the user 20.

The user interface 100 may be connected to a network such as a local area network (LAN) and a wide area network (WAN), and may also be connected to a dedicated channel for one-to-one communication with the user 20 or a terminal of the user 20. For example, the user 20 may be a desktop computer, a server system, a smart TV, an electric gate, a point of sale system, or the like.

Further, the user 20 may be a portable electronic device such as a laptop computer, a tablet PC, a mobile phone, a smart phone, an e-reader, a personal digital assistant (PDA), an enterprise digital assistant (EDA), a digital still camera, a digital video camera, a portable multimedia player (PMP), a personal navigation device or portable navigation device (PND), or a handheld game console.

The video analysis unit 200 may download the video included in the URL address received from the user 20 and divide the downloaded video into a plurality of sections. The video analysis unit 200 may generate the content of the video as text data by converting speech into text and extracting text included in the image for each section. The video analysis unit 200 may include a speech recognition unit 220 and a character recognition unit 240

The speech recognition unit 220 may recognize speech in a video and convert the speech into text (character string), thereby generating the speech in the video as text data. The speech recognition unit 220 may recognize sentences in the speech and perform natural language processing the sentences to extract meaningful text data. For example, the natural language processing may include morphological analysis, syntactic analysis, semantic analysis, and the like.

The morphological analysis may be defined as distinguishing morphemes which are minimum meaning units in a sentence. In the morphological analysis, tagging may be used for classifying into an appropriate candidate among several possible candidates of a morpheme. The speech recognition unit 220 may recognize a sentence from speech and extract text from the recognized sentence by performing the morphological analysis based on the morphological tag.

The speech recognition unit 220 according to an exemplary embodiment of the present disclosure may generate a morphological tag corresponding to a name of each brand belonging to the health and fashion fields, and perform morphological analysis based on the morphological tag. Thus, the accuracy of speech recognition for specialized terms in the health and fashion fields that do not appear frequently in general colloquial speech or conversation can be increased.

The speech recognition unit 220 may be implemented using a learned deep learning model. For example, the speech recognition unit 220 may be implemented by applying a long short-term memory (LSTM) or a gated recurrent unit (GRU). In some embodiments, an artificial intelligence model of the speech recognition unit 220 may be learned using speech data including specialized terms for health (health knowledge, health food, and medicine) and fashion (clothing, beauty, hair, and miscellaneous goods) as input data. Further, the speech recognition unit 220 may be learned using speech data in which regional pronunciation and accent are considered, as input data.

The character recognition unit 240 may recognize a text area in the image in the video and extract text from the text area, thereby generating the image in the video as text data. The character recognition unit 240 may perform preprocessing to increase a recognition rate of an original image. The character recognition unit 240 may perform modified histogram equalization or histogram equalization so that a color image can be distributed in a range of grayscale (0 to 255). The character recognition unit 240 may perform binarization to clearly distinguish a background and characters, and change the pixel value to ‘0’ when the pixel value is 255 (white) and to ‘1’ when the pixel value is 0 to 254 (gray and black).

The character recognition unit 240 may be implemented using a learned deep learning model. The character recognition unit 240 may input the image in the video to a convolutional neural network (CNN)-based model and then extract features. The character recognition unit 240 may extract a text area (text box) and a rotation angle of the text area to extract the text area from the image in the video. The character recognition unit 240 may acquire an individual character image or word image by making the text area horizontal using rotation information and cutting the image into text units.

The video analysis unit 200 may store the text data in the database 400. The video analysis unit 200 may map the sections of the video to the text data extracted from the sections of the video and store these in the database 400. The question answer system according to the exemplary embodiment of the present disclosure generates a speech and an image in the video as text data and stores the text data in the database, making it possible to provide information on core content of the video to the user at a high speed without reproducing the video. Although a case where the question answer system 40 does not include the database 400 is illustrated in FIG. 1, the question answer system 40 may include the database 400.

The machine reading comprehension engine 300 may extract the answer to the question received from the user 20 using a deep learning-based machine reading comprehension model. The machine reading comprehension engine 300 may receive the text data from the video analysis unit 200, extract the answer to the question from the text data, and provide the answer to the user interface 100.

The question answer system 40 may be configured to display a section of a video including the answer to the question in response to a question of the user. The machine reading comprehension engine 300 may extract a time stamp value of a section including the answer to the question. The value of the time stamp may indicate a point in time at which a speech including the answer to the question is spoken. The value of the time stamp may indicate a point in time when an image including the answer to the question is reproduced in the video.

The video analysis unit 200 may receive the time stamp value from the machine reading comprehension engine 300 and determine a section of the video corresponding to the time stamp value. The video analysis unit 200 may display the answer to the question and the determined section of the video on the user interface 100.

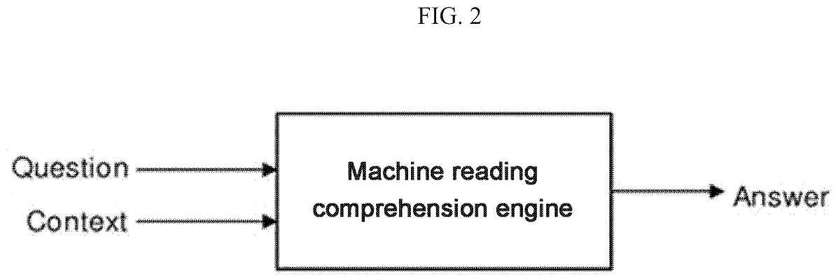

FIG. 2 is a block diagram illustrating a machine reading comprehension engine according to an exemplary embodiment of the present disclosure. Referring to FIG. 2, the machine reading comprehension engine may receive a question and a context, and extract the answer to the question from the context. In some embodiments, the machine reading comprehension engine of FIG. 2 may represent the machine reading comprehension engine 300 of FIG. 1.

Machine reading comprehension may mean artificial intelligence natural language processing for understanding the context and inferring the answer to the question in the context. The machine reading comprehension engine may receive, for example, a question “What affects falling of rain?” and a context “In meteorology, rain is atmospheric water vapor that is condensed and falls under the influence of gravity.” In this case, the machine reading comprehension engine may extract the “gravity” in the context as the answer to the question.

The machine reading comprehension engine may be trained to extract the answer in the question through learning data including a pair of a context and a question. The question may consist of syntactic transformation, vocabulary change (synonyms and common sense), comprehensive utilization of several sentence grounds, logical inference requirements, and the like.

In some embodiments, the machine reading comprehension engine may be implemented by applying a deep learning-based pre-learning language model. For example, the machine reading comprehension engine may be implemented based on Bidirectional Encoder Representations from Transformers (BERT), which is a high-performance language model released by Google. For example, the machine reading comprehension engine may be implemented based on a point network as a network that outputs an index of a part of the context corresponding to the answer to the question.

In the machine reading comprehension engine according to an exemplary embodiment of the present disclosure, text into which a speech in a video has been converted and text extracted from the image in the video may be input as text data representing the content of the video, that is, a context. The machine reading comprehension model may extract the answer to the question of the user from the text data.

The machine reading comprehension engine according to an exemplary embodiment of the present disclosure may be implemented by causing a pre-learned model to be subjected to transfer learning to be optimized for a question answer system. The machine reading comprehension engine can have improved performance in question answering for the health and fashion fields by being subjected to the transfer learning using question-answer pairs related to the health and fashion fields as input data.

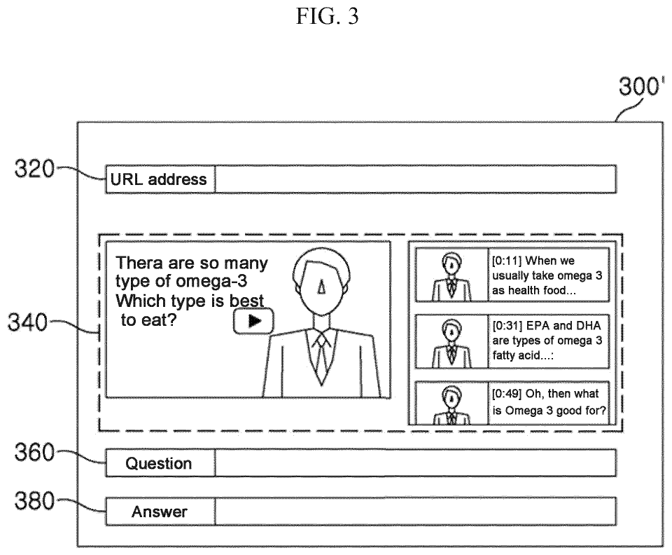

FIG. 3 illustrates a user interface according to an exemplary embodiment of the present disclosure. FIG. 3 will be described in detail with reference to FIG. 1. Referring to FIG. 3, the question answer system 40 may include a user interface 300′ that can communicate with the user 20. In some embodiments, the user interface 300′ of FIG. 3 may represent the user interface 100 of FIG. 1.

The user interface 300′ may include a first interface 320, a second interface 340, a third interface 360, and a fourth interface 380. The first interface 320 may receive the video URL address from the user 20. The video URL address may be an address indicating a path to which a video file belongs. In response to reception of the video URL address through the first interface 320, the video analysis unit 200 may download the video included in the URL address and divide the video into a plurality of sections. The video analysis unit 200 may divide the video based on a screen switching point.

The second interface 340 may display the sections divided by the video analysis unit 200 and the time stamp corresponding to each section. The video analysis unit 200 may recognize a speech, convert the speech into text, and extract text included in an image for each section, thereby generating the content of the video as text data.

The third interface 360 may receive a question from the user 20. The machine reading comprehension engine 300 may extract the answer to the question from the text data generated by the video analysis unit 200 in response to reception of the question from the user 20 through the third interface 360.

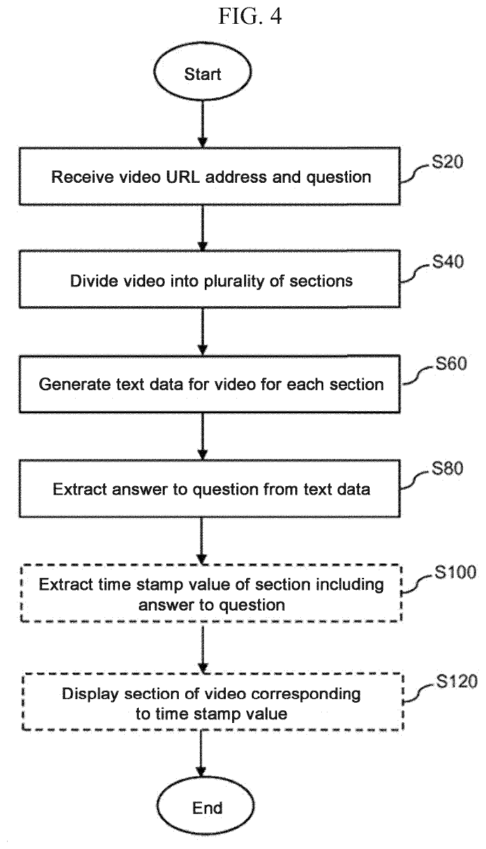

The fourth interface 380 may display the answer to the question and the section including the answer to the question. FIG. 4 is a flowchart illustrating an operation method for a question answer system according to an exemplary embodiment of the present disclosure. In some embodiments, FIG. 4 may be performed by the question answer system 40 of FIG. 1. FIG. 4 will be described in detail with reference to FIG. 1.

In step S20, the question answer system 40 may receive the video URL address and the question from the user 20. The question answer system 40 may receive the video URL address and the question through the user interface 100.

In step S40, the question answer system 40 may download the video through the URL address and divide the video into a plurality of sections. The question answer system 40 may divide the video into a plurality of sections based on a screen switching point.

In step S60, the question answer system 40 may generate the content of the video as text data for each section. The question answer system 40 may generate the content of the video as text data by recognizing a speech for each section, converting the speech into text, and extracting the text included in the image.

In step S80, the question answer system 40 may extract the answer to the question from the text data. The question answer system 40 may extract the answer to the question from the text data using a learned machine reading comprehension model.

In step S100, the question answer system 40 may extract the time stamp value of the section including the answer to the question. The value of the time stamp may indicate a point in time at which the speech including the answer to the question is spoken. The value of the time stamp may indicate a point in time when the image including the answer to the question is reproduced in the video.

In step S120, the question answer system 40 may display the section of the video corresponding to the time stamp value. Thus, the question answer system 40 may provide the section of the video including the answer to the question to the user in response to the question of the user.

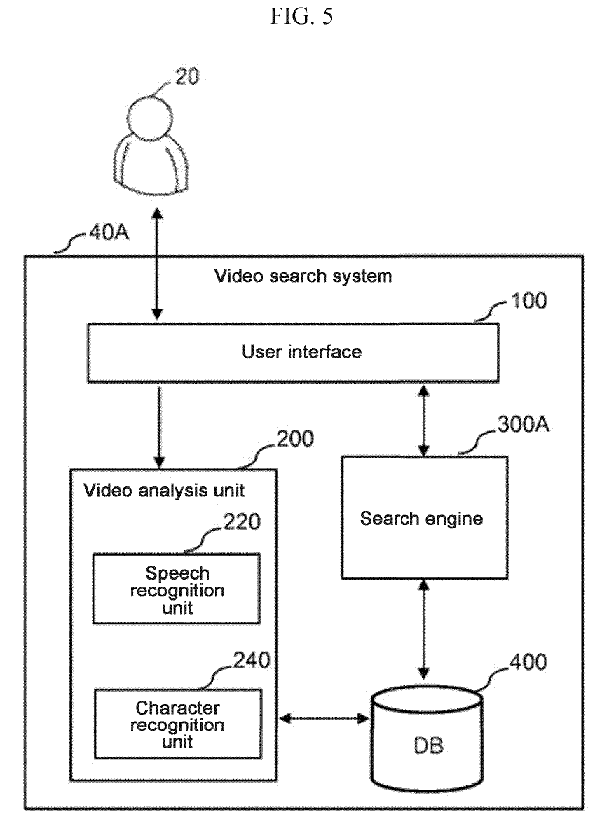

FIG. 5 is a block diagram illustrating a video search system according to an exemplary embodiment of the present disclosure. Hereinafter, content overlapping that in FIG. 1 will be omitted. The video search system according to the exemplary embodiment of the present disclosure may present an answer to a search request from the user by expanding the analysis range of the video from a speech to an image, generating text data from the speech and image in the video, and converting the text data into a database.

Referring to FIG. 5, a video search system 40A may analyze the content of the plurality of videos included in the video platform, convert the analyzed content into a database, and provide a result for the search request of the user 20 based on the data stored in the database 400. The video search system 40A may include a user interface 100, a video analysis unit 200, a search engine 300A, and a database 400.

The user interface 100 may receive an address of a video platform and a search request from the user 20. The address of the video platform may be a web address where a plurality of videos are uploaded or a plurality of videos are streamed in real time. The user interface 100 may provide the address of the video platform received from the user 20 to the video analysis unit 200. The user interface 100 may provide the search request from the user 20 to the search engine 300A, and may provide the answer generated by the search engine 300A to the user 20.

The video analysis unit 200 may perform analysis on the plurality of videos included in the video platform address received from the user 20. The video analysis unit 200 may generate the content of the video as text data by converting the speech in the video into text for each of the plurality of images and extracting the text included in the image in the video.

The video analysis unit 200 may include a speech recognition unit 220 and a character recognition unit 240. The speech recognition unit 220 may recognize the speech in the video and convert the speech into text (string), thereby generating the speech in the video as text data. The character recognition unit 240 may recognize the text area in the image in the video and extract the text from the text area, thereby generating the image in the video as text data. The video analysis unit 200 may receive the text data from the speech recognition unit 220 and the character recognition unit 240 and store the text data in the database 400.

The search engine 300A may receive the search request from the user interface 100. The search request may be a search request for a video including a specific keyword. The search engine 300A may search for text data corresponding to the keyword among information stored in the database 400 and extract a plurality of videos including the text data. The search engine 300A may display a plurality of videos including the keyword as search results through the user interface 100. The search engine 300A may be provided together with the machine reading comprehension engine 300 according to the embodiment of FIG. 1.

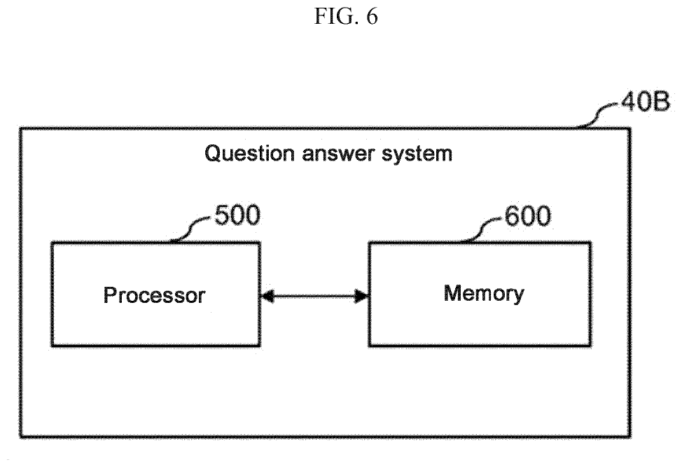

FIG. 6 is a question answer system according to an exemplary embodiment of the present disclosure. Referring to FIG. 6, a question answer system 40B may include a processor 500 and a memory 600. The processor 500 may drive the question answer system 40 of FIG. 1 by executing a program code stored in the memory 600. In other words, the question answer system 40 of FIG. 1 may be implemented as a program code, command, or mobile application program loaded into the memory 600 and executed by the processor 500. Although FIG. 6 illustrates the question answer system 40B, the same structure may be applied to the video search system 40A of FIG. 5.

The processor 500 may control an operation of the question answer system 40′ by executing software, firmware, program codes, or commands loaded into the memory 600. The processor 500 may correspond to a processor 500 included in various types of computing devices such as a personal computer (PC), a server device, a mobile device, an embedded device, and an Internet of Things (IoT) device. For example, the processor 500 may be implemented as a central processing unit (CPU), a graphics processing unit (GPU), an application processor (AP), or a neural processing unit (NPU).

The memory 600 is a hardware that stores various types of data that are processed by the processor 500, and may store, for example, various programs or applications to be driven by the processor 500. The memory 600 may include at least one of a volatile memory and a nonvolatile memory. The nonvolatile memory includes a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), a ferroelectric RAM (FeRAM), or the like. The volatile memory includes a dynamic RAM (DRAM), a static RAM (SRAM), a synchronous DRAM (SDRAM), a PRAM, a magnetic RAM (MRAM), a resistive RAM (RRAM), or the like. In an embodiment, the memory 600 may be implemented as at least one of a hard disk drive (HDD), a solid state drive (SSD), a compact flash (CF), a secure digital (SD), micro secure digital (micro-SD), a mini secure digital (Mini-SD), extreme digital (xD), and a memory stick.

Although the embodiments of the present disclosure have been described with reference to the accompanying drawings, those skilled in the art will understand that the present disclosure may be implemented in other specific forms without change in technical idea or essential characteristics thereof. Therefore, the embodiments described above should be understood as being illustrative and not limiting in all respects.

### DETAILED DESCRIPTION OF MAIN ELEMENTS

20: User
40, 40B: Question answer system
40A: Video search system
100: User interface
200: Video analysis unit
220: Speech recognition unit
240: Character recognition unit
300: Machine reading comprehension engine
300a: Search engine
400: Database

What is claimed is:

1. A question answer system for automatically generating an answer to a question of a user, the question answer system comprising:
a user interface configured to receive a video URL address and the question from the user;
a video analysis unit configured to download a video through the video URL address, divide the video into a plurality of sections, and recognize a speech, convert the speech into text, and extract text included in an image for each section to generate content of the video as text data; and
a machine reading comprehension engine configured to receive the text data from the video analysis unit and extract the answer to the question from the text data.

2. The question answer system of claim 1, wherein the machine reading comprehension engine is configured to extract a time stamp value of the section including the answer to the question.

3. The question answer system of claim 2, wherein the video analysis unit is configured to receive the time stamp value from the machine reading comprehension engine, determine the section of the video corresponding to the time stamp value, and display the answer to the question and the determined section of the video on the user interface.

4. The question answer system of claim 1, wherein the video analysis unit is configured to generate a morpheme tag corresponding to a name of each brand belonging to health and fashion fields, recognize a sentence from the speech, and perform morpheme analysis on the sentence based on the morpheme tag, thereby extracting the text from the sentence.

5. The question answer system of claim 1, further comprising:
a database, wherein
the video analysis unit is configured to map a section of the video to the text data and store the section and the text data in the database.

6. The question answer system of claim 5, further comprising:
a search engine, wherein
the search engine is configured to receive a search request from the user interface, the search request being a search request for a video including a specific keyword, and search for text data corresponding to the keyword among information stored in the database.

7. The question answer system of claim 6, wherein the search engine is configured to extract one or more videos including the text data and display the video including the keyword as a search result through the user interface.

8. The question answer system of claim 1, wherein the video analysis unit is configured to divide the video based on a screen switching point.

9. The question answer system of claim 1, wherein
the user interface includes a first interface and a second interface,
the first interface is an interface for receiving a video URL address indicating a path to which a video file belongs from a user, and
the second interface is an interface for displaying sections divided by the video analysis unit and a time stamp corresponding to each section.

10. The question answer system of claim 9, wherein
the user interface further includes a third interface and a fourth interface,
the third interface is an interface for receiving a question from a user, and
the fourth interface is an interface for displaying the answer to the question and the section of the video including the answer to the question.

11. An operation method for a question answer system for automatically generating an answer to a question of a user using at least one processor, the operation method comprising:
receiving a video URL address and a question from a user by a user interface and the at least one processor;
downloading, by the at least one processor, a video through the video URL address and dividing the video into a plurality of sections;
generating, by the at least one processor, content of the video as text data by recognizing a speech, converting the speech into text, and extracting text included in an image for each section; and
extracting, by the at least one processor, the answer to the question from the text data using a learned machine reading comprehension algorithm.

12. The operation method for a question answer system of claim 11, wherein the extracting of the answer to the question includes
extracting the time stamp value of the section including the answer to the question;
determining the section of the video corresponding to the time stamp value; and
displaying the answer to the question and the determined section of the video.

13. The operation method for a question answer system of claim 11, wherein the generating of the content of the video as text data includes
generating a morphological tag corresponding to a name of each brand belonging to health and fashion fields;
recognizing a sentence from the speech;
performing morpheme analysis on the sentence based on the morpheme tag; and
extracting the text from the sentence based on the morpheme analysis.

14. The operation method for a question answer system of claim 11, further comprising:
mapping a section of the video to the text data and storing the section and the text data in a database.

15. The operation method for a question answer system of claim 14, further comprising:
receiving, by a search engine, a search request from the user interface, the search request being a search request for a video including a specific keyword; and
searching for, by the search engine, text data corresponding to the keyword among information stored in the database.

16. The operation method for a question answer system of claim 15, further comprising:
extracting, by the search engine, one or more videos including the text data; and
displaying, by the search engine, a video including the keyword as a search result through the user interface.

17. The operation method for a question answer system of claim 11, wherein the dividing includes dividing the video based on a screen switching point.

18. The operation method for a question answer system of claim 11, wherein
the user interface includes a first interface and a second interface, and
the first interface is an interface for receiving a video URL address indicating a path to which a video file belongs from a user, and
the second interface is an interface for displaying sections divided from the video by the at least one processor and a time stamp corresponding to each section.

19. The operation method for a question answer system of claim 18, wherein
the user interface further includes a third interface and a fourth interface,
the third interface is an interface for receiving a question from a user, and
the fourth interface is an interface for displaying the answer to the question and the section of the video including the answer to the question.

20. A computer-readable non-transitory recording medium having a computer program for executing the operation method for a question answer system according to claim 11 recorded thereon.
